(19) United States
(12) Patent Application Publication
(10) Pub. No.: US 2023/0155302 A1
(43) Pub. Date: May 18, 2023

(54) Antenna and Electronic Device

(71) Applicant: Huawei Technologies Co., Ltd., Shenzhen (CN)

(72) Inventors: Min Yu, Chengdu (CN); Michael Kadichevitz, Hod Hasharon (IL); Yi Chen, Leuven (BE)

(21) Appl. No.: 17/989,244

(22) Filed: Nov. 17, 2022

(30) Foreign Application Priority Data
Nov. 18, 2021 (CN) 202111368703.6
Feb. 21, 2022 (CN) 202210158355.8

(51) Int. Cl. H01Q 21/20; H01Q 1/24; H01Q 15/14

(52) U.S. Cl. CPC H01Q 21/205; H01Q 1/246; H01Q 15/14

(57) ABSTRACT

An antenna and an electronic device are provided. The antenna includes: a radiating element pair, including a first radiating element and a second radiating element that are arranged in an annular array, where the first radiating element and the second radiating element are symmetrically arranged with respect to a symmetry line, the symmetry line passes through a center point of the annular array, and the first radiating element or the second radiating element is in an arc shape centered on the center point, or extends in a tangent direction of an arc shape centered on the center point; and a feed structure, including a first feed part and a second feed part, where the first feed part is coupled to the first radiating element, and the second feed part is coupled to the second radiating element.

### CROSS-REFERENCE TO RELATED APPLICATION

This application claims priority to Chinese Patent Application No. 202111368703.6, filed on Nov. 18, 2021, and Chinese Patent Application No. 202210158355.8, filed on Feb. 21, 2022. Both of the aforementioned applications are hereby incorporated by reference in their entireties.

### TECHNICAL FIELD

This application mainly pertains to the field of antennas. More particularly, this application relates to an antenna and an electronic device including the antenna.

### BACKGROUND

A wireless access point (access point, AP) is an access point for a user to access a wired network by using a wireless device (a mobile device such as a mobile phone or a wireless device such as a notebook computer). The wireless access point provides wireless signal coverage and serves as a bridge between a wired network and a wireless network. The wireless access point can bridge traffic from the wireless network to the wired network to add a wireless function to an existing wired network. Wireless access points are mainly used in places that require wireless monitoring, such as broadband homes, buildings, campuses, industrial parks, warehouses, and factories, and typically cover distances of tens of meters to hundreds of meters. Wireless access points can also be used for long-distance transmission. Most wireless APs are provided with an access point client mode, and therefore can be wirelessly connected to other APs to extend network coverage.

Deployment of a wireless AP depends on factors such as a place to set an AP and a building shape. APs are deployed at different heights and at different spacings because places of use vary. The wireless AP requires an antenna to provide wireless signal coverage. However, it is difficult to cope with diversified scenarios for a conventional AP because a radiation pattern of an antenna is usually fixed. Consequently, a problem such as a coverage hole or signal interference of a neighboring AP is easily caused.

### SUMMARY

This application provides a compact antenna that can provide a hybrid mode and a related electronic device.

According to a first aspect of this application, an antenna is provided. The antenna includes a radiating element pair and a feed structure. The radiating element pair includes a first radiating element and a second radiating element that are arranged in an annular array. The first radiating element and the second radiating element are symmetrically arranged with respect to a symmetry line, the symmetry line passes through a center point of the annular array, and the first radiating element or the second radiating element is in an arc shape centered on the center point, or extends in a tangent direction of an arc shape centered on the center point. The feed structure includes a first feed part and a second feed part. The first feed part is coupled to the first radiating element and configured to provide a first excitation current having a first phase and a first amplitude to the first radiating element. The second feed part is coupled to the second radiating element and configured to provide a second excitation current having a second phase and a second amplitude to the second radiating element.

By using an antenna of this structure, a hybrid-mode antenna can be implemented. Specifically, the hybrid-mode antenna has at least two operating modes. In a first operating mode, the excitation currents in the first radiating element and the second radiating element are in a same rotation direction. In this case, a radiation pattern of the antenna is a wide beam pattern. In a second operating mode, the excitation currents in the first radiating element and the second radiating element are in opposite rotation directions. In this case, a radiation pattern of the antenna is a narrow beam pattern. In the antenna of this structure, based on a superposition principle, the first mode and the second mode may be used together in any ratio, to obtain more beamwidths. In addition, an omnidirectional antenna having a plurality of beamwidths is realized in a compact structure by arranging the radiating elements of the antenna in the annular array.

In an implementation, the first excitation current and the second excitation current are from a same excitation signal. In this manner, feeding the antenna may be implemented in a cost-effective manner. In some alternative implementations, the first excitation current and the second excitation current may alternatively be separately from different excitation signals.

In an implementation, the antenna further includes a first reflector, arranged at the center of the annular array and symmetrical with respect to the center point, where the first reflector is collinear with the symmetry line. This arrangement manner enables a radiating element pair in an annular array with a large radius (for example, greater than ½ wavelength) to effectively avoid a grating lobe effect caused by an increase of a distance between radiating elements. This improves antenna gains and further improves antenna performance.

In an implementation, the antenna further includes a second reflector, arranged at the center of the annular array and symmetrical with respect to the center point, where the second reflector is perpendicular to the first reflector. This arrangement manner can further optimize performance of the antenna.

In an implementation, the first radiating element and the second radiating element each include at least two radiating sub-elements, and each of the at least two radiating sub-elements is coupled to a corresponding feed part. This arrangement manner allows the first radiator and the second radiator to use different quantities of radiating sub-elements based on different requirements, so that an arrangement manner of the antenna is more flexible.

In an implementation, the at least one radiating sub-element is in an arc shape centered on the center point, or at least a part of the at least one radiating sub-element extends in a tangent direction of an arc shape centered on the center point. This arrangement manner facilitates manufacturing of the antenna and full coverage of in a horizontal plane.

In an implementation, the antenna further includes a first parasitic radiating element arranged adjacent to the first radiating element, and a second parasitic radiating element arranged adjacent to the second radiating element. The parasitic radiating element can further optimize performance of the antenna.

In an implementation, the first parasitic radiating element is parallel to the first radiating element, and the second parasitic radiating element is parallel to the second radiating element. This arrangement manner facilitates balance of the first radiating element and the second radiating element. This helps further improve performance of the antenna.

In an implementation, the first amplitude and the second amplitude have a predetermined ratio relationship, and the first phase and the second phase have a predetermined angle relationship. In an implementation, the foregoing implementation may be implemented by feeding by using a fixed-ratio power divider. In this manner, a normal zero point of the antenna in the first operating mode can be filled. This avoids a signal coverage hole.

In an implementation, the first amplitude and the second amplitude are adjustable within a range from 0:1 to 1:1 and/or a range from 1:0 to 1:1. In this manner, a beamwidth of the first radiating element and the second radiating element can be adjusted.

In an implementation, the first phase and the second phase are adjusted to be the same or inverse. In this manner, the first radiating element and the second radiating element can work in different modes. This helps change a beamwidth.

In an implementation, the first radiating element and the second radiating element each have a length of approximately half a corresponding wavelength of an operating frequency band of the antenna in a circumferential direction.

In an implementation, the antenna further includes a power divider, including an input port, a first output port, and a second output port. An excitation signal is input to the power divider through the input port, the first output port is coupled to the first feed part, and the second output port is coupled to the second feed part. This arrangement enables the antenna to be implemented more easily and in a cost-effective manner.

In an implementation, the power divider includes a fixed-ratio power divider. In this manner, a normal zero point of the antenna in the first operating mode can be filled. This avoids a signal coverage hole.

In an implementation, the power divider includes a variable power divider, and at least one of the first phase, the first amplitude, the second phase, and the second amplitude can be adjusted. Real-time adjustment of a beamwidth and the like of the antenna can be implemented by separately feeding excitation currents whose amplitudes and phases are adjustable through a variable power divider.

A second aspect of this application provides an electronic device. The electronic device includes: the antenna according to the first aspect above; and a radio frequency module, configured to perform communication through the antenna.

### BRIEF DESCRIPTION OF DRAWINGS

The foregoing and other features, advantages, and aspects of embodiments of this application become more obvious with reference to the accompanying drawings and with reference to the following detailed descriptions. In the accompanying drawings, same or similar reference numerals represent same or similar elements.

FIG. 1 is a schematic exploded view of an electronic device according to an embodiment of this application;

FIG. 2 is a simplified schematic top view of an antenna according to an embodiment of this application;

FIG. 3(A) and FIG. 3(B) show radiation and a phase of an excitation current, and an implemented variable beamwidth that are of an antenna according to an embodiment of this application;

FIG. 4 shows a current direction diagram and a radiation pattern of an antenna that operates in a first mode according to an embodiment of this application;

FIG. 5 shows a current direction diagram and a radiation pattern of an antenna that operates in a second mode according to an embodiment of this application;

FIG. 6 shows a radiation pattern of an antenna according to an embodiment of this application;

FIG. 7 is a simplified schematic top view of an antenna according to some embodiments of this application;

FIG. 8 shows a current direction diagram of the antenna shown in FIG. 7 in a specific operating mode;

FIG. 9 is a simplified schematic top view of an antenna according to some embodiments of this application; and

FIG. 10 is a simplified schematic top view of an antenna according to some embodiments of this application.

### DESCRIPTION OF EMBODIMENTS

The following describes embodiments of this application in detail with reference to the accompanying drawings. Although some embodiments of this application are shown in the accompanying drawings, it should be understood that this application may be implemented in various forms, and should not be construed as being limited to the embodiments described herein. On the contrary, these embodiments are provided so that this application will be thoroughly and completely understood. It should be understood that the accompanying drawings and embodiments of this application are merely used as examples, but are not intended to limit the protection scope of this application.

In descriptions of embodiments of this application, terms such as “first”, “second”, and the like may refer to different or same objects.

It should be understood that in this application, “coupling” may be understood as direct coupling and/or indirect coupling. Direct coupling may also be referred to as “electrical connection”, and is understood as physical contact and electrical conduction of components. Direct coupling may also be understood as a form in which different components in a line structure are connected through physical lines that can transmit an electrical signal, such as a printed circuit board (printed circuit board, PCB) copper foil or a conducting wire. “Indirect coupling” may be understood as that two conductors are electrically conducted in a spaced/non-contact manner. In an embodiment, indirect coupling may also be referred to as capacitive coupling. For example, signal transmission is implemented by forming an equivalent capacitor through coupling in a gap between two spaced electric-conductors.

The following describes terms that may appear in embodiments of this application.

Connection: Two or more components are conducted or connected in the foregoing “electrical connection” or “indirect coupling” manner to perform signal/energy transmission, which may be referred to as connection.

Antenna pattern: The antenna pattern is also referred to as a radiation pattern. The antenna pattern refers to a pattern in which a relative field strength (a normalized modulus value) of an antenna radiation field changes with a direction at a specific distance from the antenna. The antenna pattern is usually represented by two plane patterns that are perpendicular to each other in a maximum radiation direction of an antenna.

The antenna pattern usually includes a plurality of radiation beams. A radiation beam with a highest radiation intensity is referred to as a main lobe, and the other radiation beams are referred to as side lobes. In the side lobes, a side lobe in an opposite direction of the main lobe is also referred to as a back lobe.

Beamwidth: The beamwidth includes a horizontal beamwidth and a vertical beamwidth. The horizontal beamwidth refers to an included angle between two directions that are on two sides of a direction of maximum radiation power in the horizontal direction and in which radiant power is 3 dB lower than the maximum radiation power. The vertical beamwidth refers to an included angle between two directions that are on two sides of a direction of maximum radiation power in the vertical direction and in which radiant power is 3 dB lower than the maximum radiation power.

Ground/ground plane: The ground/ground plane may usually refer to at least a part of any ground plane or any ground metal layer in an electronic device, or refer to at least a part of any combination of the foregoing ground layer, a ground plane, a ground component, or the like. The “ground/ground plane” may be used to ground a component in the electronic device. In an embodiment, the “ground/ground plane” may be a ground layer of a circuit board of an electronic device, or may be a ground metal layer formed by a ground plane formed using a middle frame of the electronic device or a metal thin film below a screen in the electronic device. In an embodiment, a circuit board may be a printed circuit board (printed circuit board, PCB). In an embodiment, a circuit board includes a dielectric substrate, a ground layer, and a wiring layer, and the wiring layer and the ground layer may be electrically connected through a via. In an embodiment, components such as a display, a touchscreen, an input button, a transmitter, a processor, a memory, a battery, a charging circuit, and a system on chip (system on chip, SoC) structure may be installed on or connected to a circuit board, or electrically connected to a wiring layer and/or a ground layer in the circuit board. For example, a radio frequency module is disposed on the wiring layer.

Any of the foregoing ground layers, or ground planes, or ground metal layers is made of conductive materials. In an embodiment, the conductive material may be any one of the following materials: copper, aluminum, stainless steel, brass and alloys thereof, copper foil on insulation laminates, aluminum foil on insulation laminates, gold foil on insulation laminates, silver-plated copper, silver-plated copper foil on insulation laminates, silver foil on insulation laminates and tin-plated copper, cloth impregnated with graphite powder, graphite-coated laminates, copper-plated laminates, brass-plated laminates and aluminum-plated laminates. A person skilled in the art may understand that the ground layer/ground plane/ground metal layer may alternatively be made of other conductive materials.

Feeder: The feeder is also referred to as a transmission line and refers to a connection line between a transceiver and a radiating element. A system that connects a radiating element of an antenna to a transceiver is referred to as a feed system. The feeder is further classified into a conducting-wire transmission line, a coaxial-line transmission line, a waveguide or a microstrip, and the like. During transmission, a modulated high-frequency oscillation current (energy) generated by a transmitter is input to a transmit antenna through the feeder (the feeder can directly transmit current waves or electromagnetic waves based on different frequencies and forms). The transmit antenna converts the high-frequency current or a guided wave (energy) into a radio wave, that is, a free electromagnetic wave (energy), and radiates the electromagnetic wave to surrounding space. During reception, a radio wave (energy) is converted into a high-frequency current or a guided wave (energy) through a receive antenna and then transmitted to a receiver through the feeder. It can be learned from the foregoing process that an antenna is not only an apparatus that radiates and receives a radio wave, but also an energy converter, and is an interface component between a circuit and a space. A feed end or a feed point is an end or a vicinity of an end that is on a radiating element and that is connected to the feeder.

Impedance and impedance matching: Impedance of an antenna usually refers to a ratio of a voltage to a current at an input end of the antenna. The antenna impedance is a measure of resistance to an electrical signal in an antenna. In general, input impedance of an antenna is a complex number. The real part is referred to as input resistance, which is represented by R; and the imaginary part is referred to as input reactance, which is represented by Xi. An antenna whose electrical length is far less than an operating wavelength has high input reactance. For example, a short dipole antenna has high capacitive reactance, and a smallring antenna has high inductive reactance. Input impedance of a half-wave dipole with a small diameter is approximately 73.1+i42.5 ohms. In an actual application, for ease of matching, it is generally expected that input reactance of a symmetrical dipole is zero. In this case, a length of the dipole is referred to as a resonance length. A length of a resonant half-wave dipole is slightly shorter than a half wavelength in free space, and in engineering, it is estimated that the length is 5% shorter than the half wavelength. The input impedance of an antenna is related to a geometric shape, a size, a feed point location, an operating wavelength, and surrounding environment of the antenna. When a diameter of a wire antenna is small, input impedance changes smoothly with frequency, and impedance bandwidth of the antenna is wide.

A main purpose of studying antenna impedance is to realize matching between an antenna and a feeder. To match a transmit antenna with a feeder, input impedance of an antenna should be equal to characteristic impedance of the feeder. To match a receive antenna with a receiver, the input impedance of the antenna should be equal to a conjugate complex number of load impedance. The receiver usually has impedance of a real number. When the impedance of the antenna is a complex number, a matching network needs to be used to remove a reactance part of the antenna and make resistance parts of the antenna and the receiver equal.

When the antenna matches the feeder, power transmitted from the transmitter to the antenna or from the antenna to the receiver is the maximum. In this case, no reflected wave appears on the feeder, a reflection coefficient is equal to 0, and a standing wave coefficient is equal to 1. A matching quality of the antenna and the feeder is measured by a reflection coefficient or a standing wave ratio at an input end of the antenna. For the transmit antenna, if matching is poor, radiant power of the antenna decreases, loss on the feeder increases, and a power capacity of the feeder decreases. In serious cases, transmitter frequency “pulling” occurs, that is, an oscillation frequency changes.

Radiating element: the radiating element is an apparatus used to receive and transmit electromagnetic wave radiation in an antenna. In some cases, an “antenna” is a radiating element in a narrow sense. The radiating element converts guided wave energy from a transmitter into a radio wave, or converts a radio wave into guided wave energy to radiate and receive a radio wave. A modulated high-frequency current energy (or guided wave energy) generated by the transmitter is transmitted to a transmit radiating element through a feeder. The radiating element converts the energy into specific polarized electromagnetic wave energy and transmits the energy in a required direction. A receive radiating element converts specific polarized electromagnetic wave energy from a specific direction in space into modulated high-frequency current energy, and transmits the energy to an input end of a receiver through the feeder.

The radiating element may be a conductor having a specific shape and size, such as a wire antenna. A wire antenna consists of one or more metal conducting wires whose cable sizes are much smaller than a wavelength and whose lengths are comparable to the wavelength. The wire antenna is mainly used in long, medium, short, and ultrashort wave bands as a transmit antenna or receive antenna. Main forms of wire antennas include the following: a dipole antenna, a half-wave dipole antenna, a cage antenna, a monopole antenna, a whip antenna, a tower antenna, a spherical antenna, a magnetic antenna, a V-shaped antenna, a rhombic antenna, a fishbone antenna, a Yagi antenna, a log-periodic antenna, and an antenna array. For details, see a non-directional antenna, a weakly-directional antenna, and a highly-directional antenna. For a dipole antenna, each dipole antenna usually includes two radiation stubs, and each stub is fed by a feed part from a feed end of the radiation stub.

The radiating element may also be a slot or a slit formed on a conductor. For example, an antenna formed by slotting on a conductor surface is referred to as a slot antenna or a slotted antenna. A typical shape of a slot is a long strip with a length of approximately half a wavelength. The slot may perform feeding by using a transmission line bridged on a narrow side of the slot, or may perform feeding by using a waveguide or a resonant cavity. In this case, a radio frequency electromagnetic field is excited above the slot, and an electromagnetic wave is radiated to space.

In addition, limitations mentioned in this application that is related to a location and a distance, such as being in the middle or at a middle location, are all described in terms of a current process level, and are not absolutely-strict definitions in mathematics. For example, a middle location of a conductor refers to a midpoint of the conductor, and in actual application, it means that a junction between another component (for example, a feeder or a grounding stub) and the conductor covers the midpoint. A middle location of a slot or a middle location on a side of the slot refers to a midpoint of the side of the slot. In actual application, it means that a junction between another component (for example, a feeder) and the side covers the midpoint. In actual application, that a slit is provided in a middle location on one side of a slot means that a location at which the slit is located on the side covers a midpoint of the side.

The feed point mentioned in the foregoing content of this application may be any point in a connection area (which may also be referred to as a junction) of the feeder and the radiating element, for example, a center point. A distance from a point (such as a feed point, a connection point, or a ground point) to a slot or from a slot to a point may refer to a distance from the point to a midpoint of the slot, or may refer to a distance from the point to two ends of the slot.

Co-directional/reverse distribution of currents mentioned in the foregoing content of this application should be understood as that directions of main currents on conductors on a same side are co-directional/reverse. For example, when co-directionally distributed currents are excited on an annular conductor (for example, a current path is also annular), it should be understood that although main currents excited on conductors on two sides of the annular conductor (for example, on conductors around a slot, or on conductors on two sides of a slot) are in reverse directions, the main currents still meet a definition of the co-directionally distributed currents in this application.

The technical solutions provided in this application are applicable to an electronic device using one or more of the following communications technologies: a Bluetooth (Bluetooth, BT) communications technology, a global positioning system (Global Positioning System, GPS) communications technology, a wireless local area network (WLAN) communications technology, a cellular network communications technology, and the like. The electronic device in embodiments of this application may include a device that directly connects a user front end to an operator network, including but not limited to a wireless access point, a telephone set, a wireless router, a firewall, a computer, an optical modem, a 4G-to-Wi-Fi wireless router, and the like. The electronic device in embodiments of this application may also include a mobile phone, a tablet computer, a notebook computer, a smart household, a smart band, a smartwatch, a smart helmet, smart glasses, and the like. Alternatively, the electronic device may be a handheld device or a computing device that has a wireless communication function, another processing device connected to a wireless modem, an in-vehicle device, or the like.

Specifically, a wireless access point is a network device that allows a WLAN device to connect to a local area network. The access point acts as a central transmitter and receiver for radio signals. Mainstream wireless access points support Wi-Fi, and are most commonly used in homes, factories, shopping malls, and large supermarkets, supporting public Internet hotspots and commercial networks, to adapt to surge of wireless mobile devices in use. The access point may be integrated into a wired router, or may be a stand-alone device.

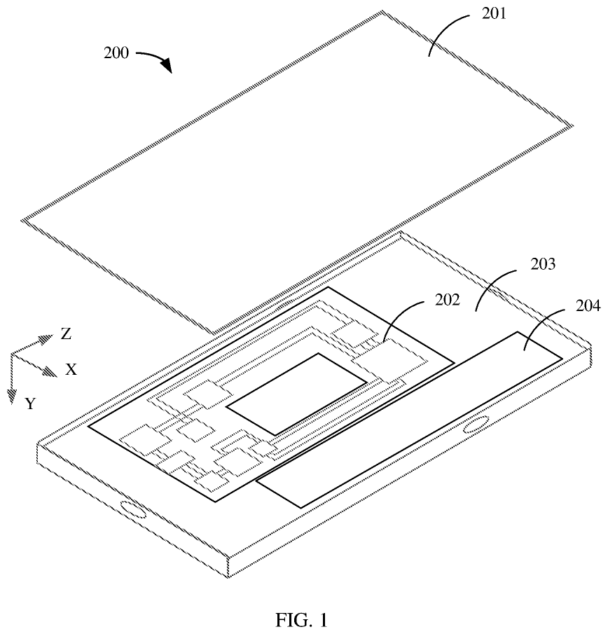

An electronic device such as a wireless access point is shown in FIG. 1. The electronic device 200 usually includes a housing 203, a cover 201, a circuit board 202, and an antenna 100. The housing 203 and the cover 201 may be assembled to form internal space for accommodating the circuit board 202 and the antenna 100. The circuit board 202 is a carrier configured to carry a processing unit of the electronic device 200 and a processing circuit of an antenna (for example, a transceiver and the like). The antenna 100 and the circuit board 202 may be disposed separately, and the antenna 100 is usually disposed at a location adjacent to an inner side of the housing 203. The antenna 100 is connected to the processing circuit of the antenna by using a transmission line such as a coaxial cable or a microstrip, to feed an antenna unit of the antenna 100.

Certainly, it should be understood that a structure and an arrangement of the electronic device shown in FIG. 1 are merely examples, and are not intended to limit the protection scope of this application. Another electronic device of any appropriate structure or arrangement is also possible as long as applicable. For example, in some embodiments, the antenna 100 may alternatively be integrated into the circuit board 202, or disposed as a part of a frame of the housing 203, or at least partially disposed outside the housing 203. In addition, in an embodiment, a form of the antenna 100 may be an antenna form based on a flexible printed circuit (flexible printed circuit, FPC), an antenna form based on laser direct structuring (laser direct structuring, LDS), or an antenna form such as a microstrip antenna (microstrip antenna). The following mainly uses the structure shown in FIG. 1 as an example to describe the electronic device 200 according to this embodiment of this application. It should be understood that another electronic device 200 is similar. Details are not separately described below.

A signal coverage area of a wireless access point is usually related to factors such as a radiation pattern of an antenna and a height that is set. However, in a conventional access point, a radiation pattern and a disposition location of an antenna are usually fixed, and a radiation range of the access point is also fixed. As a result, it is difficult for current wireless access points to adapt to diversified environments such as factories, shopping malls, and supermarkets, and coverage holes and signal interference between adjacent access points are easily caused.

In addition, a plurality of wireless access points are often used for networking in scenarios such as a large stadium, a shopping mall, a supermarket, a factory, and an office region. A quantity of users changes with time, and density of users in a specific area in the place also changes with time and various factors. A conventional fixed antenna 100 cannot adjust a radiation pattern, an arrangement location, and the like, and consequently, it is difficult to implement a real-time change of a signal coverage area (for example, adjustment with a change of density of users in a specific area) to perform network load balance. Therefore, an antenna 100 that can adjust a beamwidth and a radiation pattern and a corresponding electronic device 200 are urgently needed.

In a conventional solution, two types of antennas are usually used in an electronic device such as a wireless access point. One type of antenna has a large beamwidth, and the other type of antenna has a small beamwidth. In some solutions, different antennas are used in different scenarios to meet demands for different beamwidths. However, a problem caused by this solution is that a beamwidth is still relatively fixed (there are basically two beamwidths) As a result, real-time adjustment cannot be implemented actually. In addition, because a plurality of antennas are required, occupied space is large, which is unfavorable to miniaturization of the electronic device.

A phased array technology is another conventional solution that can implement real-time beamwidth adjustment. A phased array antenna refers to an antenna whose pattern shape is changed by controlling a feed phase of a radiating element in an array antenna. The phased array technology uses a plurality of antennas to form an array. A total beam of the array is superimposed and combined by radiation waves of all radiation elements. A radiation phase and a radiation angle of each radiating element may be separately controlled, to implement arbitrary change and adjustment of the total beamwidth. However, a main problem of this solution is that costs are too high. Because this technology requires a plurality of antennas, to control a radiation phase and a radiation angle of each antenna, a large quantity of controllable phase shifters, attenuators, and the like are required, resulting in extremely high costs.

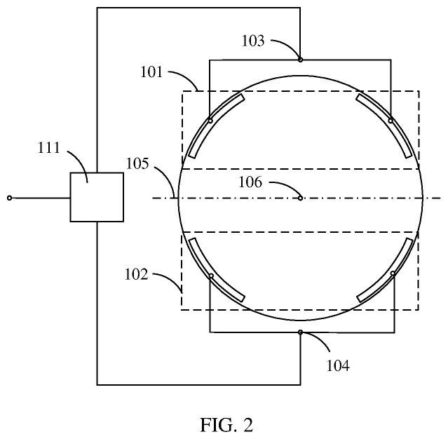

To resolve or at least partially resolve the foregoing problems or other potential problems of conventional wireless access points in a cost-effective manner, an embodiment of this application provides an antenna 100 and an electronic device 200 using the antenna 100. FIG. 2 shows an example of a simplified top view of the antenna 100. As shown in FIG. 2, in general, the antenna 100 according to this embodiment of this disclosure includes a radiating element pair and a feed structure. The radiating element pair is arranged in an annular array, and includes a first radiating element 101 and a second radiating element 102. The first radiating element 101 and the second radiating element 102 may be symmetrically arranged with respect to a symmetry line 105. The symmetry line 105 refers to a straight line passing through a center point 106 of the annular array.

In some embodiments, the radiating element pair may be a microstrip arranged on a circuit board. A microstrip is a transmission line that can be made into a line used to transmit microwave signals on a printed circuit board. The microstrip consists of a conducting wire, a ground, and a dielectric layer. For example, the antenna 100, a coupler, a filter, and a power divider may be formed by microstrips. Microstrips are cheaper, lighter, and more compact than conventional waveguide technologies. The circuit board may be, for example, any appropriate circuit board that can bear a microstrip, such as a flexible circuit board or a printed circuit board. Certainly, it should be understood that, provided that there is a corresponding annular array arrangement, the radiating element pair may be formed in any appropriate manner. For example, in some alternative embodiments, the antenna 100 may be formed by using an annular array formed by any appropriate conductor. The following mainly describes embodiments of this application by using the microstrip arranged on the circuit board shown in FIG. 2 as an example. It should be understood that other cases are similar, and details are not separately described below.

In addition, the first radiating element 101 or the second radiating element 102 shown in FIG. 2 has two separate radiating sub-elements. It should be understood that this arrangement manner of the radiating elements is also an example, and is not intended to limit the protection scope of this disclosure. The first radiating element 101 or the second radiating element 102 may use any other appropriate structure or arrangement. For example, in some embodiments, the first radiating element 101 and the second radiating element 102 may alternatively each include one, three, or more radiating sub-elements. The following mainly describes an inventive concept according to this application by using an example in which each radiating element shown in FIG. 2 includes two radiating sub-elements. Other cases are similar, and details are not separately described below.

The first radiating element 101 or the second radiating element 102 has an arc shape approximately centered on the center point 106 of the annular array or extends in a tangent direction of an arc shape centered on the center point 106, and basically does not have another radially-extended stub. For example, in some embodiments, each radiating sub-element may be approximately in an arc shape, and a center may be located at the center point 106 of the annular array. Certainly, it should be understood that this is merely an example, and is not intended to limit the protection scope of this disclosure. Any other appropriate structure or arrangement is also possible. For example, in some alternative embodiments, at least a part of each radiating element or each radiating sub-element may extend in a tangent direction of an arc shape centered on the center point. For example, in some embodiments, the radiating sub-element may be in a straight-line shape and extend substantially in a tangent direction of an arc shape centered on the center point. In some alternative embodiments, the radiating sub-element may substantially be in a bending shape having a plurality of bending lines or any other appropriate shape, and a part of the radiating sub-element extends in a tangent direction of an arc shape centered on the center point.

An electrical length of each of the first radiating element 101 and the second radiating element 102 in a circumferential direction may be substantially equal to approximately half a corresponding wavelength of a frequency band in which the antenna 100 operates. “Approximately” herein means that, considering factors such as a manufacturing process and impedance matching, an electrical length L of the radiating element may be within a range of 10% (or 5%) lower than half the corresponding wavelength 2 to 10% (or 5%) higher than half the corresponding wavelength λ, that is, ½λ×(1−10%)≤L≤½λ×(1+10%) or ½λ×(1−5%)≤L≤½λ×(1+5%). The wavelength in this application may be a wavelength corresponding to a center frequency of an operating frequency band supported by the antenna, or a wavelength in a medium corresponding to a center frequency of an operating frequency band supported by the antenna. For example, assuming that a center frequency of a B1 uplink frequency band (a resonance frequency ranges from 1920 MHz to 1980 MHz) is 1955 MHz, the wavelength may be a wavelength calculated by using the frequency 1955 MHz, or a wavelength in a medium calculated by using the frequency (referred to as a medium wavelength for short). Not limited to the center frequency, “wavelength/medium wavelength” may also refer to a wavelength/medium wavelength corresponding to a resonance frequency, or a non-center frequency of an operating frequency band. For ease of understanding, the medium wavelength mentioned in embodiments of this application may be simply understood as a wavelength.

For example, for a frequency band corresponding to a resonance frequency ranging from 1920 MHz to 1980 MHz of the antenna 100, a wavelength corresponding to a center frequency 1955 MHz of the frequency band is 15 cm. Therefore, it is obtained through calculation that a length of the first radiating element 101 or the second radiating element 102 in the circumferential direction is approximately 5 cm to 9 cm. For the solution shown in FIG. 2, each radiating sub-element in the first radiating element 101 may have an equal length, and basically has an electrical length of ¼ wavelength. In terms of a physical length, considering factors such as impedance matching, a length of each radiating sub-element is approximately 3 cm to 5 cm.

The feed structure includes a first feed part 103 and a second feed part 104 that are respectively coupled to the first radiating element 101 and the second radiating element 102. Considering factors such as impedance matching, as shown in FIG. 2, a feed point of each feed part coupled to a radiating sub-element of a corresponding radiating element may be located at a middle location on each radiating sub-element. It should be understood that this is merely an example, and is not intended to limit the protection scope of this disclosure. As long as impedance matching can be implemented, any other appropriate location for feeding is also possible. The following mainly describes an inventive concept of this disclosure by using a location shown in FIG. 2. It should be understood that feeding at another location is similar, and details are not separately described below.

The first feed part 103 is configured to provide an excitation current having an adjustable phase and an adjustable amplitude to the first radiating element 101. For ease of understanding, the excitation current provided by the first feed part 103 is referred to as a first excitation current, and has a first phase and a first amplitude. The second feed part 104 is configured to provide a second excitation current having a second phase and a second amplitude to the second radiating element 102.

It can be learned from the foregoing description that the antenna in this embodiment of this application uses a radiating element pair that has an arc-shaped structure or a tangent direction-extending structure and that is axisymmetrically disposed. In this manner, a hybrid-mode antenna can be implemented by feeding the first excitation current and the second excitation current to the two radiating elements respectively. Specifically, the hybrid-mode antenna has at least two operating modes. In a first operating mode, the excitation currents in the first radiating element 101 and the second radiating element 102 are in a same rotation direction. In this case, radiation of the antenna has a wide beam. In a second operating mode, the excitation currents in the first radiating element 101 and the second radiating element 102 are in opposite rotation directions. In this case, radiation of the antenna has a narrow beam. In the antenna of this structure, based on a superposition principle, the first mode and the second mode may be used together in any ratio, to obtain more beamwidths. In addition, the radiating element pair of the antenna 100 is arranged in the annular array, and occupy small space, to implement a compact antenna design. An omnidirectional antenna having a plurality of beamwidths is realized in a compact structure by arranging the radiating elements of the antenna in the annular array.

In some embodiments, in a process of using the antenna, at least one of the first amplitude, the second amplitude, the first phase, and the second phase can be adjusted in real time or online based on parameters such as a beamwidth required by the antenna. In some embodiments, the first amplitude and the second amplitude may have one or more predetermined ratio relationships.

A solution of two feed parts of the feed structure may be implemented by using a power divider 111. In other words, in some embodiments, the antenna 100 may further include the power divider 111. The power divider 111, also referred to as a power divider for short, is a device that divides one path of input signal energy into two or more paths of equal or unequal output energy. Technical specifications of the power divider include a frequency range, withstand power, distribution loss from a main circuit to a branch circuit, insertion loss between input and output, isolation between branch ports, and a voltage standing wave ratio of each port.

For example, in some embodiments, the power divider 111 may include a variable power divider. In this case, the first feed part 103 is coupled to a first output port of the power divider 111, and the second feed part 104 is coupled to a second output port of the power divider 111. The two output ports of the variable power divider may output two paths of excitation currents whose phases have a variable relationship and amplitudes have a variable relationship. Amplitudes and phases of the first excitation current and the second excitation current may change within a specific range. For example, at least one of the first phase of the first excitation current, the first amplitude of the first excitation current, the second phase of the second excitation current, and the second amplitude of the second excitation current can be adjusted, to implement a required beamwidth of the antenna. In this manner, a beamwidth of the antenna can be adjusted in real time.

In some alternative embodiments, the power divider 111 includes a fixed-ratio power divider. Amplitudes of excitation currents that are output by two output ports of the fixed-ratio power divider have a predetermined ratio relationship, and phases of the excitation currents have a predetermined phase relationship. In this manner, a normal zero point in a radiation pattern used when the antenna operates in the first mode can be filled, to eliminate a signal coverage hole.

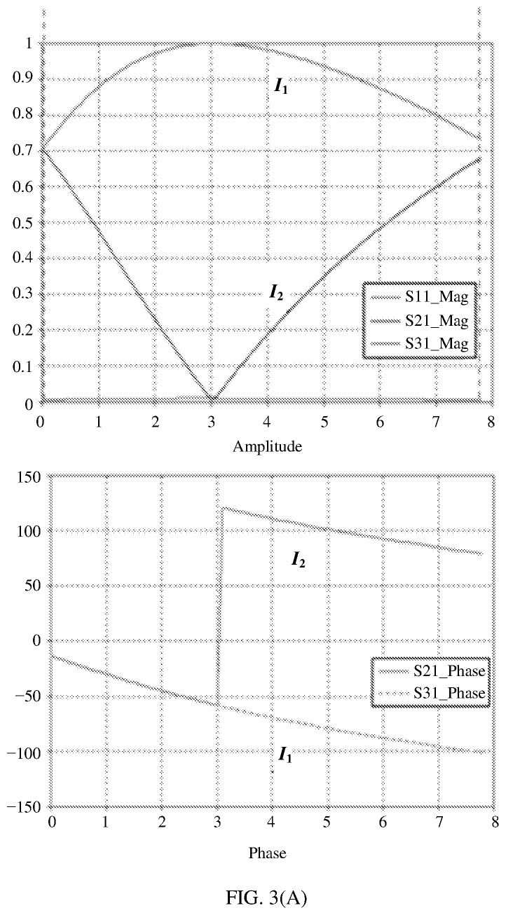

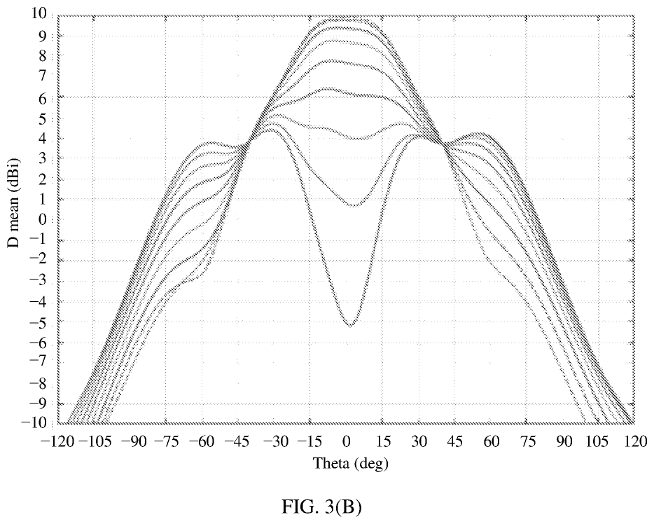

The following describes an inventive concept according to this disclosure by using an example in which the first feed part 103 and the second feed part 104 are respectively coupled to the two output ports of the variable power divider. FIG. 3(A) shows a changing relationship diagram of amplitudes and phases of the first excitation current I1 and the second excitation current I2 that may be provided by the first feed part 103 and the second feed part 104 respectively in this case. FIG. 3(B) shows a generated variable beamwidth. It can be learned that a required radiation pattern and beamwidth can be generated by changing a ratio (adjusted to another ratio) of the amplitudes of the excitation currents and/or a difference (from 0° to 180°) between the phases of the excitation currents, to meet a requirement for a radiation direction of the electronic device 200. For example, when the difference between the phases of the excitation currents is adjusted from 0° to 180°, an antenna beam may swing leftward and rightward, so that the antenna radiates to different locations as required, to expand a radiation range of the antenna.

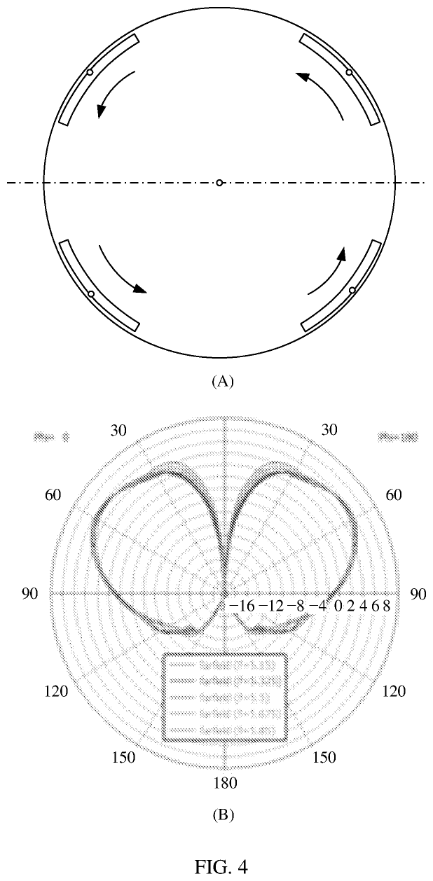

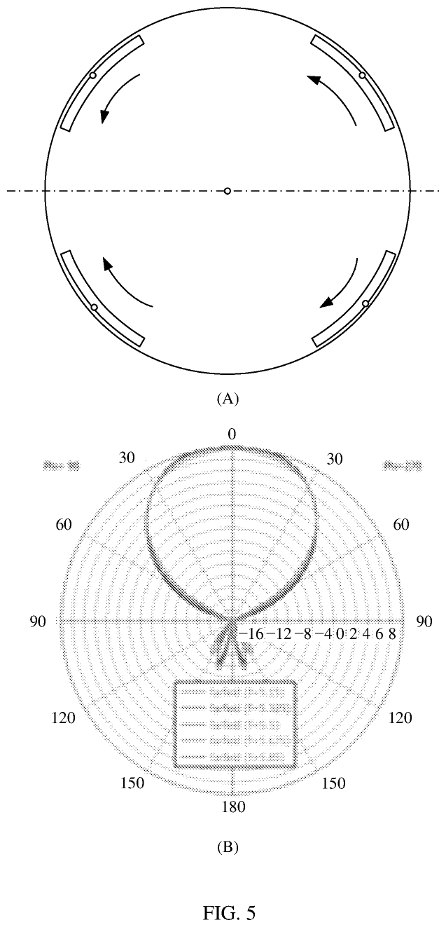

In some embodiments, a ratio relationship between current amplitudes of the excitation currents provided by the first feed part 103 and the second feed part 104 may be adjusted within a range from 0:1 to 1:1 and/or a range from 1:1 to 1:0, where these ratio ranges include endpoint values. In other words, a ratio relationship between current amplitudes of the excitation currents provided by the first feed part 103 and the second feed part 104 may be 0:1, 1:0, 1:1, or any ratio relationship within a range from 0:1 to 1:1 and/or a range from 1:1 to 1:0. For example, in some embodiments, the current amplitudes of the excitation currents provided by the first feed part 103 and the second feed part 104 may be equal to each other (that is, a case of 1:1), and the phases of the excitation currents provided by the first feed part 103 and the second feed part 104 may also be the same, which corresponds to a case in which a horizontal coordinate is 0 as shown in FIG. 3(A). In this manner, when the amplitudes of the excitation currents provided by the two feed parts are equal to each other and the phases of the excitation currents provided by the two feed parts are the same, as shown in (A) in FIG. 4, induced currents in a same rotation direction are excited on the radiating element pair. In this case, the antenna 100 operates in the first mode mentioned above. In this mode, a radiation pattern of the antenna 100 is shown in (B) in FIG. 4. In this case, the antenna 100 has a wide beamwidth. As mentioned above, in some embodiments, a normal point in the radiation pattern used when the antenna operates in the first mode may be filled in a manner of providing feeding by using a fixed-ratio power divider, to eliminate a signal coverage hole. When the amplitudes of the excitation currents provided by the two feed parts are equal to each other and the phases of the excitation currents provided by the two feed parts are inverse, as shown in (A) in FIG. 5, currents in opposite directions are excited on the radiating element pair. In this case, the antenna 100 works in the second mode. In this mode, a radiation pattern of the antenna 100 is shown in (B) in FIG. 5. In this case, the antenna 100 has a narrow beamwidth.

It can be learned that two different modes corresponding to different radiation patterns and beamwidths can be excited when the ratio of the amplitudes of the excitation currents provided by the first feed part 103 and the second feed part 104 is 1:1 and only the phases of the excitation currents provided by the first feed part 103 and the second feed part 104 are changed. Based on a superposition principle, the first mode and the second mode may be used together at any ratio (for example, from 0:1 to 1:1 and/or from 1:1 to 1:0). In this case, only a ratio (adjusted to another ratio) of the amplitudes of the excitation currents and/or a difference (from 0° to 180°) between the phases of the excitation currents need to be changed, so that the antenna 100 can operate in more operating modes. Therefore, a radiation pattern of the antenna may be adjusted to various forms such as an axisymmetric form or an asymmetric form based on a requirement.

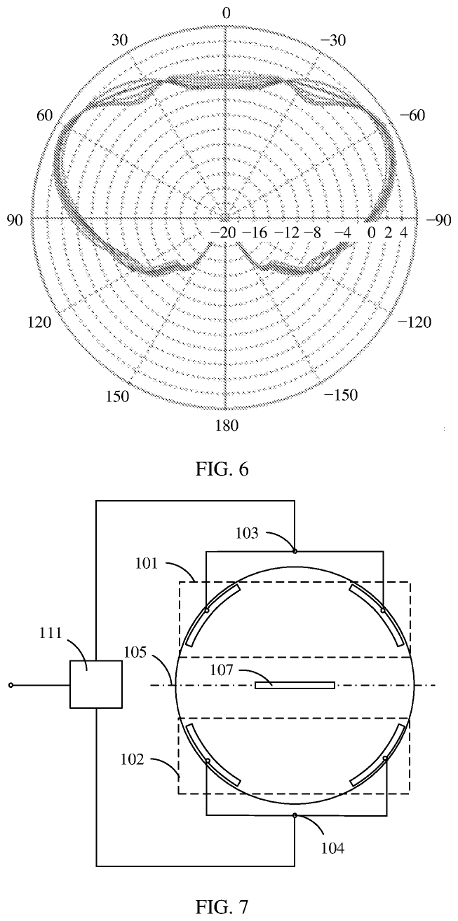

In some embodiments, the power divider 111 mentioned above may be a variable power divider, so that excitation currents whose amplitudes have a predetermined ratio and phases have a predetermined relationship can be provided at output ports. In this manner, a radiation direction and a beamwidth of the antenna 100 can be adjusted in real time in a more convenient and cost-effective manner. In some alternative embodiments, the power divider 111 may be a fixed-ratio power divider, and the first feed part 103 and the second feed part 104 are also corresponding to two output ports of the fixed-ratio power divider respectively. By providing excitation currents that have one or more fixed proportions (for example, a fixed ratio may be any appropriate ratio from 1000:1 to 2:1) of a first amplitude and a second amplitude, a coverage hole of the radiation pattern (as shown in FIG. 4) in the first mode may also be filled. Therefore, as shown in FIG. 6, a signal coverage hole is avoided and a beamwidth is expanded.

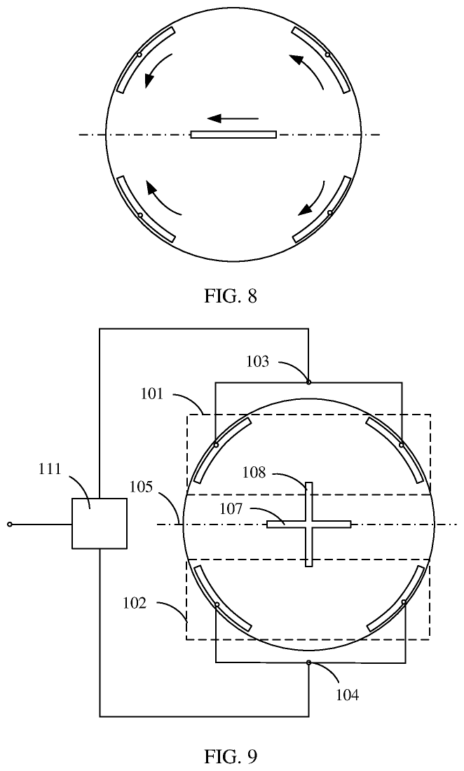

In an embodiment, when a radius of the annular array is large, because a distance between the radiating elements is correspondingly increased in this case, a grating lobe effect may occur in a radiation pattern of the antenna. Grating lobes are radiation lobes in addition to a main lobe whose intensity is roughly as high as intensity of the main lobe due to in-phase superposition of field strength in other directions. The grating lobes occupy radiation energy and reduce antenna gains. In this case, to further improve performance of the antenna 100, for example, when a radius of the annular array is greater than approximately ½ wavelength, a reflector may be disposed in the center of the antenna 100. For example, in some embodiments, the first reflector 107 may be disposed along the symmetry line 105 at the center of the annular array of the radiating element pair of the antenna 100. As shown in FIG. 7, the first reflector 107 may be symmetrical with respect to the center point 106 and collinear with the symmetry line 105. Being collinear herein indicates that a side edge or a central line of the first reflector 107 that is in an extension direction is collinear with the symmetric line. In this case, when equal-amplitude inverse-phase excitation currents are provided on the first radiating element 101 and the second radiating element 102 respectively, currents in directions shown in FIG. 8 are excited on the radiating elements and the first reflector 107. In this manner, the first reflector 107 may be used as a parasitic radiating element to radiate energy outward in a manner approximately the same as a manner of the first radiating element 101 and the second radiating element 102. In this case, existence of the first reflector 107 reduces a distance between the radiating elements. Reducing the distance between the radiating elements can effectively avoid generation of the grating lobe effect. This increases antenna gains and further provides an improved second mode.

In some embodiments, as shown in FIG. 9, in addition to the first reflector 107, a second reflector 108 arranged perpendicular to the first reflector 107 may be further disposed at the center of the annular array. In some embodiments, the first reflector 107 and the second reflector 108 may be integrally formed or formed in any other appropriate manner. In this case, the first reflector 107 and the second reflector 108 form a cross-shaped radiating element that operates in an operating frequency band of the antenna and that uses the center point 106 of the antenna as a center. In this manner, a dual-polarized reflector can be implemented, to further improve performance of the antenna 100.

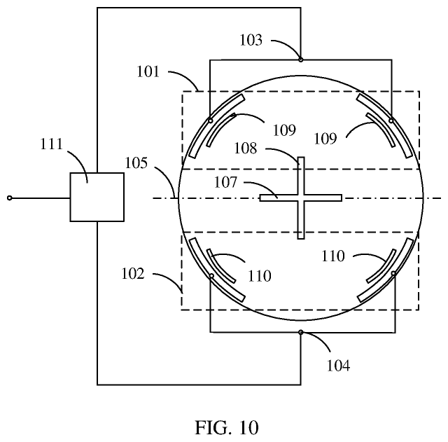

As shown in FIG. 10, in some embodiments, to further improve performance of the antenna 100, the antenna 100 may further include a parasitic radiating element. Specifically, the antenna 100 may include a first parasitic radiating element 109 arranged adjacent to the first radiating element 101. When the first radiating element 101 includes a plurality of radiating sub-elements, the first parasitic radiating element 109 may also include a plurality of corresponding parasitic radiating sub-elements. Similarly, the antenna 100 may further include a second parasitic radiating element 110 arranged adjacent to the second radiating element 102, and a quantity of parasitic radiating sub-elements in the second parasitic radiating element 110 may correspond to a quantity of radiating sub-elements of the second radiating element 102. In addition, the first parasitic radiating element 109 is parallel to the first radiating element, and the second parasitic radiating element 110 is parallel to the second radiating element.

That a parasitic radiating element is parallel to a corresponding radiating element may include a plurality of cases. For example, in some embodiments, when the first radiating element 101 is in an arc shape, that the first parasitic radiating element 109 is parallel to the first radiating element 101 means that the first parasitic radiating element 109 is also in an arc shape and is disposed concentrically with the first radiating element 101. Similarly, when the second radiating element 102 is in an arc shape, that the second parasitic radiating element 110 is parallel to the second radiating element 102 means that the second parasitic radiating element 110 is also in an arc shape and is disposed concentrically with the second radiating element 102.

In some embodiments, when the first radiating element 101 is in a straight-line shape, that the first parasitic radiating element 109 is parallel to the first radiating element 101 means that the first parasitic radiating element 109 is also in a straight-line shape and is arranged in parallel to the first radiating element 101. Similarly, when the second radiating element 102 is in a straight-line shape, that the second parasitic radiating element 110 is parallel to the second radiating element 102 means that the second parasitic radiating element 110 is also in a straight-line shape and is arranged in parallel to the second radiating element 102.

In some embodiments, when the first radiating element 101 is in a bending shape having a plurality of bending lines or any other appropriate shape, that the first parasitic radiating element 109 is parallel to the first radiating element 101 means that the first parasitic radiating element 109 also has a shape similar to the shape of the first radiating element 101 or to a shape of a part of the first radiating element 101, and the first parasitic radiating element 109 is parallel to or concentric to the first radiating element 101. A case of the second radiating element 102 and the second parasitic radiating element 110 is similar to the foregoing case. Details are not described herein again.

Certainly, in some embodiments, a shape of the radiating element may alternatively be different with a shape of the corresponding parasitic radiating element. For example, in some embodiments, the first radiating element 101 or the second radiating element 102 may be in a straight-line shape, and the straight-line shape extends along a tangent direction of an arc shape centered on the center point 106. Different from the foregoing embodiment, the first parasitic radiating element 109 or the second parasitic radiating element 110 may be correspondingly in an arc shape centered on the center point 106. Alternatively, the first radiating element 101 or the second radiating element 102 may be in an arc shape centered on the center point 106, and the first parasitic radiating element 109 or the second parasitic radiating element 110 may be correspondingly in a straight-line shape, and the straight-line shape extends along a tangent direction of an arc shape centered on the center point 106.

In addition, in some embodiments, similar to the first radiating element 101 and the second radiating element 102, the first parasitic radiating element 109 and the second parasitic radiating element 110 may be symmetrically arranged with respect to the symmetry line 105. For example, the first parasitic radiating element 109 and the second parasitic radiating element 110 may be concentrically arranged with the first radiating element 101 and the second radiating element 102, respectively. In this manner, an operating frequency band of the antenna can be expanded, and a wide beamwidth of the antenna 100 can be implemented at the same time, to further improve performance of the antenna 100.

As shown in FIG. 10, a radiating sub-element of each parasitic radiating element may be arranged adjacent to a center location of a corresponding radiating sub-element of a radiating element. In addition, a length of the radiating sub-element of each parasitic radiating element may be approximately ⅓ to ¾ of a length of the corresponding radiating sub-element of a radiating element, for example, ½ of a length of the corresponding radiating sub-element. It should be understood that this is merely an example, and is not intended to limit the protection scope of this disclosure. Any other appropriate arrangement or structure is similar. For example, in some alternative embodiments, for some frequency bands, to optimize performance of the antenna 100, a length of each parasitic radiating element may be approximately equal to a length of a corresponding radiating element.

Although this application has been described in language specific to structural features and/or methodological acts, it should be understood that the subject matter defined in the appended claims is not necessarily limited to the specific features or acts described above. On the contrary, the specific features and acts described above are merely examples of implementing the claims.

1. An antenna, comprising:
a radiating element pair, comprising a first radiating element and a second radiating element arranged in an annular array, wherein the first radiating element and the second radiating element are symmetrically arranged with respect to a symmetry line, wherein the symmetry line passes through a center point of the annular array, and wherein the first radiating element or the second radiating element is in an arc shape centered on the center point, or extends in a tangent direction of an arc shape centered on the center point; and
a feed structure, comprising a first feed part and a second feed part, wherein the first feed part is coupled to the first radiating element and configured to supply a first excitation current having a first phase and a first amplitude to the first radiating element, and wherein the second feed part is coupled to the second radiating element and configured to supply a second excitation current having a second phase and a second amplitude to the second radiating element.

2. The antenna according to claim 1, wherein the first excitation current and the second excitation current are based on a same excitation signal.

3. The antenna according to claim 1, further comprising:
a first reflector, arranged at the center of the annular array and symmetrical with respect to the center point, wherein the first reflector is collinear with the symmetry line.

4. The antenna according to claim 3, further comprising:
a second reflector, arranged at the center of the annular array and symmetrical with respect to the center point, wherein the second reflector is perpendicular to the first reflector.

5. The antenna according to claim 1, wherein the first radiating element and the second radiating element each comprise at least two radiating sub-elements, and each of the at least two radiating sub-elements is coupled to a corresponding feed part.

6. The antenna according to claim 1, further comprising:
a first parasitic radiating element, arranged adjacent to the first radiating element; and
a second parasitic radiating element, arranged adjacent to the second radiating element.

7. The antenna according to claim 6, wherein the first parasitic radiating element is parallel to the first radiating element, and the second parasitic radiating element is parallel to the second radiating element.

8. The antenna according to claim 1, wherein the first amplitude and the second amplitude have a predetermined ratio relationship, and
wherein the first phase and the second phase have a predetermined phase relationship.

9. The antenna according to claim 1, wherein a ratio relationship between the first amplitude and the second amplitude are adjustable within at least one of a range from 0:1 to 1:1 or a range from 1:0 to 1:1.

10. The antenna according to claim 1, wherein the first phase and the second phase are adjusted to be the same or inverse.

11. The antenna according to claim 1, wherein the first radiating element and the second radiating element each have a length of approximately half a corresponding wavelength of an operating frequency band of the antenna in a circumferential direction.

12. The antenna according to claim 1, further comprising:
a power divider, comprising an input port, a first output port, and a second output port, wherein the excitation signal is input to the power divider through the input port, and wherein the first output port is coupled to the first feed part, and the second output port is coupled to the second feed part.

13. The antenna according to claim 12, wherein the power divider comprises a fixed ratio power divider.

14. The antenna according to claim 12, wherein the power divider comprises a variable power divider, and wherein at least one of the first phase of the first excitation current, the first amplitude of the first excitation current, the second phase of the second excitation current, or the second amplitude of the second excitation current is adjustable.

15. An electronic device, comprising:
an antenna comprising:
a radiating element pair, comprising a first radiating element and a second radiating element arranged in an annular array, wherein the first radiating element and the second radiating element are symmetrically arranged with respect to a symmetry line, wherein the symmetry line passes through a center point of the annular array, and wherein the first radiating element or the second radiating element is in an arc shape centered on the center point or extends in a tangent direction of an arc shape centered on the center point; and
a feed structure, comprising a first feed part and a second feed part, wherein the first feed part is coupled to the first radiating element and configured to supply a first excitation current having a first phase and a first amplitude to the first radiating element, and wherein the second feed part is coupled to the second radiating element and configured to supply a second excitation current having a second phase and a second amplitude to the second radiating element; and
a radio frequency module, configured to perform communication through the antenna.

16. The electronic device according to claim 15, wherein the first excitation current and the second excitation current are based on a same excitation signal.

17. The electronic device according to claim 15, wherein the antenna further comprises:
a first reflector, arranged at the center of the annular array and symmetrical with respect to the center point, wherein the first reflector is collinear with the symmetry line.

18. The antenna according to claim 17, wherein the antenna further comprises:
a second reflector, arranged at the center of the annular array and symmetrical with respect to the center point, wherein the second reflector is perpendicular to the first reflector.

19. The electronic device according to claim 15, wherein the first radiating element and the second radiating element each comprise at least two radiating sub-elements, and each of the at least two radiating sub-elements is coupled to a corresponding feed part.

20. The electronic device according to claim 15, wherein the antenna further comprises:
a first parasitic radiating element, arranged adjacent to the first radiating element; and
a second parasitic radiating element, arranged adjacent to the second radiating element.
